(19) United States
(12) Patent Application Publication
(10) Pub. No.: US 2010/0053136 A1
(43) Pub. Date: Mar. 4, 2010

(54) GRADATION VOLTAGE CORRECTION SYSTEM AND DISPLAY DEVICE USING THE SAME

(75) Inventors: Yuuki Ohta, Osaka (JP); Tetsuya Hamada, Osaka (JP)

Correspondence Address: HARNESS, DICKEY & PIERCE, P.L.C., P.O. BOX 8910, RESTON, VA, 20195, US

(73) Assignee: Sharp Kabushiki Kaisha, Osaka-shi, Osaka (JP)

(21) Appl. No.: 12/312,810

(22) PCT Filed: Jul. 6, 2007
(86) PCT No.: PCT/JP2007/063536

§ 371 Date: May 28, 2009

(30) Foreign Application Priority Data
Dec. 6, 2006 (JP) 2006-329575

(51) Int. Cl. G09G 5/00

(52) U.S. Cl. 345/211; 345/87

(57) ABSTRACT

In one embodiment of the present invention, a gradation voltage correction system is provided in a liquid crystal display device that is configured to be capable of displaying a color image, and corrects gradation voltages to be supplied to a plurality of pixels. The gradation voltage correction system includes a color sensor (chromaticity change acquiring portion) for acquiring a change in chromaticity of illumination light from light-emitting diodes and a correction determining portion for determining correction values for each color of the red, green, and blue pixels based on the detection (acquisition) results of the color sensor.

### TECHNICAL FIELD

The present invention relates to a gradation voltage correction system for correcting a gradation voltage in accordance with information to be displayed, particularly a gradation voltage correction system used in a non-luminous display device capable of displaying a color image, and a display device using the same.

### BACKGROUND ART

In recent years, e.g., a liquid crystal display device has been widely used for a liquid crystal television, a monitor, a portable telephone, etc. as a flat panel display having features such as a smaller thickness and a lighter weight compared to a conventional cathode ray tube. Such a liquid crystal display device includes a backlight device and a liquid crystal panel. The backlight device emits light and the liquid crystal panel displays a desired image by serving as a shutter with respect to light from a light source provided in the backlight device.

The backlight device has been provided as an edge light type or a direct light type in which a linear light source composed of a cold-cathode tube or a hot-cathode tube is located on the side or underside of the liquid crystal panel. However, the cold-cathode tube etc. contain mercury and have not been easily recyclable when they are discarded. Therefore, a backlight device using a mercury-free light-emitting diode (LED) as a light source and a liquid crystal display device including the backlight device have been proposed (see, e.g., JP 2004-21147 A).

The above conventional liquid crystal display device includes three colors of light-emitting diodes that emit red (R) light, green (G) light, and blue (B) light, respectively, and provides white light by mixing these three colors of light. The conventional liquid crystal display device also includes a sensor for detecting light from the individual light-emitting diodes and adjusts the amount of light of each of the R, G, and B light-emitting diodes based on the detection results of the sensor, thereby suppressing changes in brightness and chromaticity of the corresponding light-emitting diodes over time.

### DISCLOSURE OF INVENTION

### Problem to be Solved by the Invention

In the above light sources such as the cold-cathode tube and the light-emitting diode, the chromaticity of the illumination light can be changed due to aged deterioration or lighting initial characteristics. Specifically, e.g., in the case of the cold-cathode tube, mercury filled in the inside of the tube solidifies over operation Lighting) time, and the vapor pressure of the mercury is reduced, leading to a change in chromaticity of the illumination light.

In the case of the light-emitting diode, a light-emitting chip is generally protected by providing a package made of a transparent synthetic resin such as a silicon resin or an acrylic resin on the emission surface side of the light-emitting chip. However, the above synthetic resin is likely to cause aged deterioration such as yellowing due to the effect of heat from the light-emitting chip or the like. Therefore, in the light-emitting diode, the package is colored by the aged deterioration, resulting in a change in chromaticity of the illumination light. Moreover, a white light-emitting diode is composed of, e.g., a blue light-emitting diode and a yellow phosphor or green and red phosphors provided on the surface of the light-emitting chip of the blue light-emitting diode. Thus, the chromaticity of the illumination light is changed by the aged deterioration of the phosphors as well as coloring of the package.

When the chromaticity change of the illumination light occurs in the conventional liquid crystal display device, each of the R, G, and B pixels is irradiated with the illumination light with a reduced degree of whiteness (e.g., light mixed with yellow caused by the yellowing), so that the display quality is degraded.

In the conventional liquid crystal display device, the chromaticity change of the illumination light can be suppressed in such a manner that the amount of light of the corresponding light-emitting diodes is adjusted by varying the supply current values of the individual R, G, and B light-emitting diodes based on the detection results of the sensor. However, depending on the degree of coloring (e.g., yellowing) of the package, the chromaticity change of the illumination light cannot be sufficiently suppressed only by varying the supply current values of the individual R, G, and B light-emitting diodes. In some cases, therefore, it is not possible to prevent degradation of the display quality of this conventional liquid display device.

When the light source that emits monochromatic light (white light) such as the cold-cathode tube or the white light-emitting diode is used in the backlight device, even if the supply current value of the light source is varied as in the case of the above conventional liquid crystal display device, the chromaticity change due to aged deterioration of the light source cannot be suppressed at all. Thus, in the conventional liquid crystal display device using the light source that emits white light in the backlight device, when the chromaticity of the illumination light is changed due to aged deterioration of the light source or the like, it is not possible to prevent degradation of the display quality caused by the chromaticity change of the illumination light.

With the foregoing in mind, it is an object of the present invention to provide a gradation voltage correction system that can prevent degradation of the display quality even if the chromaticity of illumination light from a light source is changed, and a display device using the same.

### Means for Solving Problem

In order to achieve the above object, a gradation voltage correction system of the present invention corrects gradation voltages to be supplied to a plurality of red, green, and blue pixels provided in a display device that is configured to be capable of displaying information pixel by pixel using illumination light from a light source and includes the following: a chromaticity change acquiring portion for acquiring a change in chromaticity of the illumination light; a correction determining portion for determining correction values of the gradation voltages for each color of the red, green, and blue pixels based on the acquisition results of the chromaticity change acquiring portion; and a gradation voltage output portion for outputting the correction values of the gradation voltages from the correction determining portion to the display device.

In the gradation voltage correction system with the above configuration, not only the chromaticity change acquiring portion for acquiring a change in chromaticity of the illumination light from the light source, but also the correction determining portion for determining correction values of the gradation voltages for each color of the red, green, and blue pixels based on the chromaticity change of the illumination light acquired by the chromaticity change acquiring portion are provided. Moreover, the gradation voltage output portion for outputting the correction values of the gradation voltages determined by the correction determining portion to the display device is provided. With this configuration, unlike the conventional examples, even if the chromaticity of the illumination light is changed due to aged deterioration of the light source, the correction determining portion can determine appropriate correction values of the gradation voltages for each color of the red, green, and blue pixels so as to cancel the chromaticity change of the illumination light, and the correction values of the gradation voltages thus determined can be output to the display device via the gradation voltage output portion. Consequently, unlike the conventional examples, this configuration can prevent degradation of the display quality even if the chromaticity of the illumination light from the light source is changed, regardless of the luminous color or type of the light source.

In the gradation voltage correction system, the chromaticity change acquiring portion may include a color sensor for detecting chromaticity of the illumination light.

In this case, the correction determining portion can obtain the actually measured value of the change in chromaticity of the illumination light and determine the correction values of the gradation voltages with high precision, thus reliably preventing degradation of the display quality.

In the gradation voltage correction system, it is preferable that the color sensor is located in a region other than the effective display area of a display portion provided in the display device.

In this case, the placement of the color sensor can reliably prevent reductions in brightness and display quality.

In the gradation voltage correction system, the chromaticity change acquiring portion may include a timer for measuring a lighting time of the light source.

This configuration can prevent degradation of the display quality while simplifying the structure of the gradation voltage correction system.

In the gradation voltage correction system, it is preferable that the timer measures both a cumulative time including all the lighting times of the light source that have been added together and an elapsed time from a lighting start point at which the light source is turned on.

This configuration can reliably prevent degradation of the display quality even if the chromaticity is changed due to aged deterioration of the light source and lighting initial characteristics.

In the gradation voltage correction system, the chromaticity change acquiring portion may include a temperature sensor for detecting an ambient temperature of the light source.

This configuration can reliably prevent degradation of the display quality even if the emission characteristics of the light source vary with ambient temperature, and thus the chromaticity of the illumination light is changed.

In the gradation voltage correction system, it is preferable that the correction determining portion includes a look-up table that correlates the acquisition results of the chromaticity change acquiring portion with the correction values of the gradation voltages.

In this case, the correction determining portion can instantly determine the correction values of the gradation voltages and immediately prevent degradation of the display quality even if the chromaticity of the illumination light is changed.

A display device of the present invention uses any of the above gradation voltage correction systems.

The display device with the above configuration can easily provide excellent display performance because of the use of the gradation voltage correction system that can prevent degradation of the display quality even if the chromaticity of the illumination light from the light source is changed.

The display device may include a liquid crystal panel used as a display portion for displaying information. In the liquid crystal panel, a transmittance of the illumination light may be changed for each pixel in accordance with the correction values of the gradation voltages from the gradation voltage output portion.

This configuration can easily achieve a liquid crystal display device with excellent display performance that is capable of preventing degradation of the display quality even if the chromaticity of the illumination light from the light source is changed.

### EFFECTS OF THE INVENTION

The present invention can provide a gradation voltage correction system that can prevent degradation of the display quality even if the chromaticity of the illumination light from the light source is changed, and a display device using the same.

### BRIEF DESCRIPTION OF DRAWINGS

FIG. 1 is a schematic view showing a gradation voltage correction system and a liquid crystal display device according to Embodiment 1 of the present invention.

FIG. 2 is a plan view showing the configuration of the main portion of the backlight device shown in FIG. 1.

FIG. 3 is a diagram for explaining the configuration of the main portion of the gradation voltage correction system and the liquid crystal panel shown in FIG. 1.

FIG. 4 is graphs showing the effect of the gradation voltage correction system: 4A is a graph showing the relationship between input gradation and output voltages for each of R, G, and B pixels when the gradation voltage correction system does not correct gradation voltages; 4B is a graph showing the relationship between input gradation and output voltages for each of the R, G, and B pixels when the gradation voltage correction system corrects the gradation voltages.

FIG. 5 is a schematic view showing a gradation voltage correction system and a liquid crystal display device according to Embodiment 2 of the present invention.

FIG. 6 is a schematic view showing a gradation voltage correction system and a liquid crystal display device according to Embodiment 3 of the present invention.

FIG. 7 is a schematic view showing a gradation voltage correction system and a liquid crystal display device according to Embodiment 4 of the present invention.

FIG. 8 is a diagram for explaining the configuration of the main portion of the gradation voltage correction system and the liquid crystal panel shown in FIG. 7.

FIG. 9 is a schematic view showing a gradation voltage correction system and a liquid crystal display device according to Embodiment 5 of the present invention.

FIG. 10 is a diagram for explaining the configuration of the main portion of the gradation voltage correction system and the liquid crystal panel shown in FIG. 9.

### DESCRIPTION OF THE INVENTION

Hereinafter, preferred embodiments of a gradation voltage correction system and a display device of the present invention will be described with reference to the drawings. The following description gives an example of applying the present invention to a transmission type liquid crystal display device.

### Embodiment 1

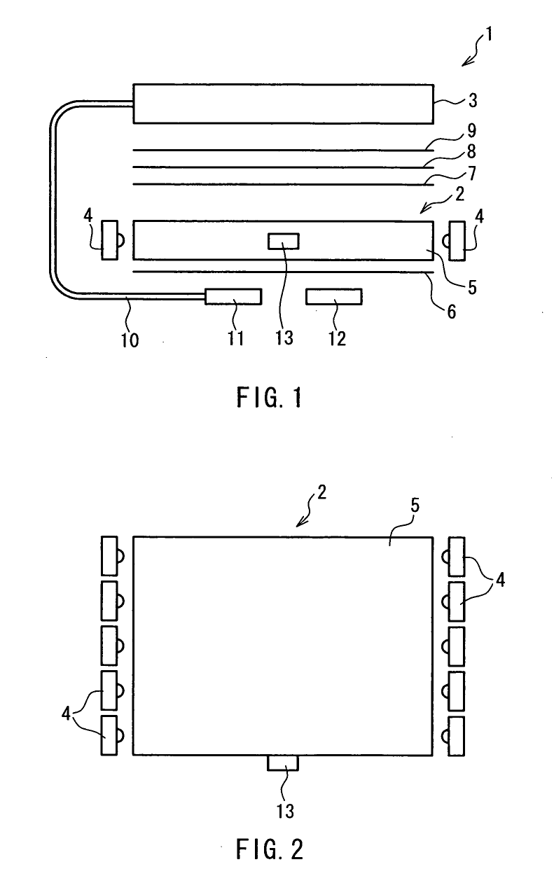

FIG. 1 is a schematic view showing a gradation voltage correction system and a liquid crystal display device according to Embodiment 1 of the present invention. FIG. 2 is a plan view showing the configuration of the main portion of the backlight device shown in FIG. 1. In FIGS. 1 and 2, the liquid crystal display device 1 of this embodiment includes a backlight device 2 and a liquid crystal panel 3 that is irradiated with light from the backlight device 2 and serves as a display portion for displaying information. The backlight device 2 and the liquid crystal panel 3 are integrated as a transmission type liquid crystal display device 1.

The backlight device 2 includes a plurality of light-emitting diodes 4 serving as a light source, a light guide plate 5 into which light from each of the plurality of light-emitting diodes 4 is introduced, and a reflection sheet 6 located on the side of the light guide plate 5 that faces away from the liquid crystal panel 3. The backlight device 2 directs planar illumination light from the light guide plate 5 to the liquid crystal panel 3. In the backlight device 2, as shown in FIG. 2, the plurality of light-emitting diodes 4 are dispersedly placed in left and right arrangement regions of the light-emitting diodes 4 that are located on the left and right sides of the light guide plate 5 in FIG. 2, respectively.

The plurality of light-emitting diodes 4 include, e.g., white light-emitting diodes for emitting white light. In the plurality of light-emitting diodes 4, the number, type, size, etc. of the light-emitting diodes 4 are selected in accordance with the size of the liquid crystal panel 3 and the display performance such as brightness or display quality required for the liquid crystal panel 3. Specifically, e.g., a power LED with a power consumption of about 1 W or a chip LED with a power consumption of about 70 mW is suitably used as each of the light-emitting diodes 4.

In the liquid crystal display device 1, e.g., a polarizing sheet 7, a prism (condensing) sheet 8, and a diffusion sheet 9 are disposed between the liquid crystal panel 3 and the light guide plate 5. These optical sheets appropriately increase the brightness of the illumination light from the backlight device 2, and thus can improve the display performance of the liquid crystal panel 3.

In the liquid crystal display device 1, signal lines (source lines) and control lines (gate lines), as will be described later, included in the liquid crystal panel 3 are connected to a drive control circuit 11 via an FPC (flexible printed circuit) 10. Moreover, in the liquid crystal display device 1, the drive control circuit 11 controls the driving of the signal lines and the control lines pixel by pixel. As shown in FIG. 1, a lighting drive circuit 12 for lighting and driving the plurality of light-emitting diodes 4 is provided in the vicinity of the drive control circuit 11. The lighting drive circuit 12 is configured to light and drive the light-emitting diodes 4, e.g., by PWM dimming.

The light guide plate 5 is made of a synthetic resin such as a transparent acrylic resin. As shown in FIG. 1, the light guide plate 5 has a rectangular cross section, and the left and right surfaces of the light guide plate 5 in FIG. 2 function as incident surfaces. In other words, light from each of the plurality of light-emitting diodes 4 placed in the left and right regions is introduced onto the left and right surfaces of the light guide plate 5, respectively. The light from the light-emitting diodes 4 that enters the light guide plate 5 through the left surface is guided toward the right surface and appropriately emitted from the emission surface of the light guide plate 5 (facing the diffusion sheet 9) to the liquid crystal panel 3 as illumination light by the reflection sheet 6. Similarly, the light from the light-emitting diodes 4 that enters the light guide plate 5 through the right surface is guided toward the left surface and appropriately emitted from the emission surface of the light guide plate 5 to the liquid crystal panel 3 as illumination light by the reflection sheet 6.

Specifically, the light-emitting diodes 4 of the left and right regions, the light guide plate 5, and the reflection sheet 6 are housed in a case (not shown), and light from the individual light-emitting diodes 4 is efficiently introduced into the inside of the light guide plate 5 through the corresponding left or right surface directly or indirectly via a reflector, while a leakage of light to the outside is minimized. Thus, in the backlight device 2, the light utilization efficiency of each of the light-emitting diodes 4 can be easily improved, so that high brightness of the illumination light can be readily achieved.

A color sensor 13 is located opposite to the lower surface of the light guide plate 5 in FIG. 2 and detects the chromaticity of the illumination light directed to the liquid crystal panel 3. The color sensor 13 is included in the gradation voltage correction system of this embodiment and used as a chromaticity change acquiring portion for acquiring a change in chromaticity of the illumination light. As shown in FIG. 2, the color sensor 13 is located opposite to the lower surface of the light guide plate 5 that differs from the emission surface i.e., the upper surface in FIG. 1) of the light guide plate 5. Thus, the color sensor 13 is located in a region other than the effective display area of the liquid crystal panel (display portion) 3. The placement of the color sensor 13 can reliably prevent reductions in brightness and display quality of the liquid crystal panel 3.

Specifically, the color sensor 13 is a light-receiving element that can detect the chromaticity of R, G, and B colors of light separately, and detects the chromaticity of each of red light, green light, and blue light contained in the illumination light. Moreover, the color sensor 13 is configured to output the detected chromaticity of each of the red light, the green light, and the blue light to a correction determining portion (as will be described later) at predetermined time intervals.

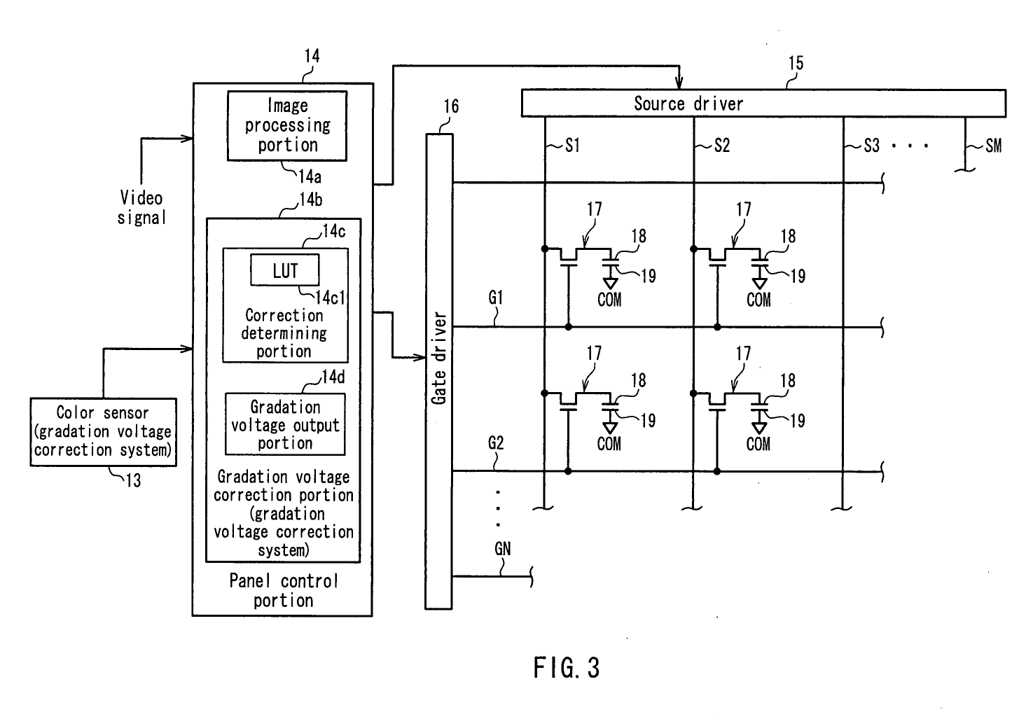

Hereinafter, the main portion of the gradation voltage correction system of this embodiment will be described in detail with reference to FIG. 3 as well as FIGS. 1 and 2.

FIG. 3 is a diagram for explaining the configuration of the main portion of the gradation voltage correction system and the liquid crystal panel shown in FIG. 1. In FIG. 3, a panel control portion 14 receives a video signal from the outside of the liquid crystal display device 1 via a signal source (not shown) such as a personal computer. The panel control portion 14 is provided in the drive control circuit 11 (FIG. 1) and configured to substantially control the driving of the signal lines and the control lines pixel by pixel in accordance with the input video signal.

Specifically, the panel control portion 14 includes an image processing portion 14a that generates indication signals for a source driver 15 and a gate driver 16 based on the video signal. Moreover, the panel control portion 14 integrally incorporates a gradation voltage correction portion 14b that is included in the gradation voltage correction system of this embodiment. The indication signals for the source driver 15 generated by the image processing portion 14a are corrected by the gradation voltage correction portion 14b and then output to the source driver 15, as will be described in detail later.

The source driver 15 and the gate driver 16 are drive circuits for driving each of a plurality of pixels provided in the liquid crystal panel 3. A plurality of signal lines S1 to SM (M is an integer of 2 or more) are connected to the source driver 15, and a plurality of control lines G1 to GN (N is an integer of 2 or more) are connected to the gate driver 16. These signal lines S1 to SM and the control lines G1 to GN are arranged in a matrix, and areas for the individual pixels are formed in between the signal lines and the control lines that cross over each other. The plurality of pixels include red, green, and blue pixels. The red, green, and blue pixels are sequentially arranged in parallel to the control lines G1 to GN, e.g., in the indicated order.

The gates of switching elements 17 provided for each pixel are connected to the control lines G1 to GN. The sources of the switching elements 17 are connected to the signal lines S1 to SM. Moreover, pixel electrodes 18 provided for each pixel are connected to the drains of the switching elements 17. In each of the pixels, a common electrode 19 is located opposite to the pixel electrode 18 with a liquid crystal layer that is provided in the liquid crystal panel 3 interposed between them. The gate driver 16 successively outputs gate signals for turning the gates of the corresponding switching elements 17 on to the control lines G1 to GN based on the indication signals from the image processing portion 14a. The source driver 15 outputs voltage signals (gradation voltages) in accordance with the brightness (gradation) of a display image to the corresponding signal lines S1 to SM based on the indication signals from a gradation voltage output portion 14d, as will be described later.

The gradation voltage correction portion 14b includes a correction determining portion 14c and the gradation voltage output portion 14d. The correction determining portion 14c determines correction values of the gradation voltages for each color of the red, green, and blue pixels based on the detection results of the color sensor 13. The gradation voltage output portion 14d receives the indication signals for the source driver 15 from the image processing portion 14a and the correction values of the gradation voltages determined by the correction determining portion 14c, corrects the indication signals for the source driver 15 using the input correction values, and outputs the corrected indication signals to the source driver 15.

The correction determining portion 14c uses a look-up table (also referred to as “LUT” in the following) 14c1 that is connected to the color sensor 13 and the gradation voltage output portion 14d. Therefore, even if the chromaticity of the illumination light is changed, the correction determining portion 14c determines the correction values of the gradation voltages for each color of the red, green, and blue pixels so as to cancel the chromaticity change of the illumination light. In the LUT 14c1, the chromaticity included in the detection results of the color sensor 13 and the optimum correction values of the gradation voltages have been previously obtained by performing a test or simulation and correlated for each color of red light, green light, and blue light. In the correction determining portion 14c, when the detection results of the color sensor 13 are input to the LUT 14c1, the correction values of the gradation voltages for each color of the red, green, and blue pixels in accordance with the detection results are immediately transmitted to the gradation voltage output portion 14d.

Upon receiving the correction values of the gradation voltages for each color of the red, green, and blue pixels from the LUT 14c1, the gradation voltage output portion 14d corrects the indication signals for the source driver 15 that have been input from the image processing portion 14a using the correction values and then outputs the corrected indication signals as new indication signals to the source driver 15. In other words, the gradation voltage output portion 14d corrects the gradation voltages for each of the red, green, and blue pixels, which have been determined in accordance with the video signal by the image processing portion 14a, based on the correction values of the respective colors transmitted from the LUT 14c1, and provides new gradation voltages. Then, the gradation voltage output portion 14d generates indication signals that indicate the new gradation voltages for each of the red, green, and blue pixels and outputs them to the source driver 15. Thus, in the liquid crystal panel 3, the transmittance of the illumination light from the backlight device 2 is changed for each of the red, green, and blue pixels in accordance with the new gradation voltages from the gradation voltage output portion 14d. Consequently, even if the chromaticity of white light from the light-emitting diodes 4 is changed due to, e.g., aged deterioration of the light-emitting diodes 4, lighting initial characteristics, and/or ambient temperature changes, it is possible to prevent degradation of the display quality of the liquid crystal display device 1.

Besides the above explanation, the gradation voltage output portion 14d may output the correction values of the gradation voltages determined by the correction determining portion 14c to the image processing portion 14a, and then the image processing portion 14a may determine new gradation voltages for each of the red, green, and blue pixels based on the correction values and output the new gradation voltages as indication signals to the source driver 15.

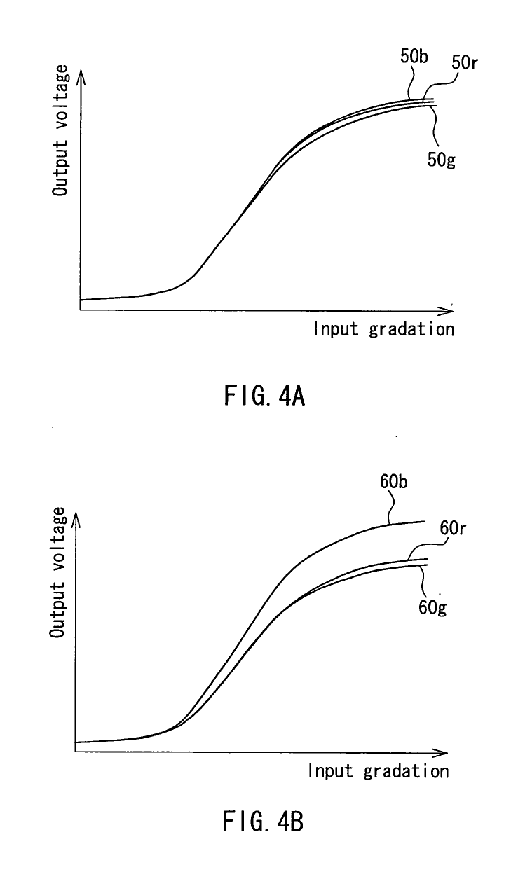

Hereinafter, the operation of the gradation voltage correction system of this embodiment will be described in detail with reference to FIG. 4. The following description gives an example in which yellowing occurs due to aged deterioration of the light-emitting diodes 4, and yellow caused by the yellowing is mixed with white light from the light-emitting diodes 4, thus reducing the degree of whiteness of the illumination light that is to be directed to the liquid crystal panel 3.

FIG. 4 is graphs showing the effect of the gradation voltage correction system. FIG. 4A is a graph showing the relationship between the input gradation and the output voltages for each of the R, G, and B pixels when the gradation voltage correction system does not correct the gradation voltages. FIG. 4B is a graph showing the relationship between the input gradation and the output voltages for each of the R, G, and B pixels when the gradation voltage correction system corrects the gradation voltages.

When no yellowing occurs in the light-emitting diodes 4, the gradation voltage correction portion 14b outputs the gradation voltages determined by the image processing portion 14a to the source driver 15 without any modification, as indicated by curves 50r, 50g, and 50b in FIG. 4A. That is, the image processing portion 14a determines the gradation voltages for each of the red, green, and blue pixels based on the video signal (input gradation) input to the panel control portion 14. On the other hand, since no yellowing occurs in the light-emitting diodes 4, the chromaticity of each of red light, green light, and blue light detected by the color sensor 13 does not require a gradation voltage correction. Therefore, as the correction values of red, green, and blue, values of ±0 are output from the LUT 14c1 to the gradation voltage output portion 14d. Consequently, in the red, green, and blue pixels, the gradation voltages (output voltages) in accordance with the input gradation are output from the corresponding signal lines via the source driver 15, as indicated by the curves 50r, 50g, and 50b, respectively.

When yellowing occurs in the light-emitting diodes 4 and the degree of whiteness of the illumination light is reduced, the chromaticity of each of red light, green light, and blue light detected by the color sensor 13 requires a gradation voltage correction. Therefore, the correction values of red, green, and blue in accordance with the detection results of the color sensor 13 are output for each color from the LUT 14c1 to the gradation voltage output portion 14d. Specifically, e.g., a correction value that increases the gradation voltage for the blue pixels and correction values (of ±0) that do not modify the gradation voltages for the red and green pixels are output so as to cancel yellow contained in the illumination light due to the yellowing. Consequently, in the red and green pixels, the gradation voltages (output voltages) in accordance with the input gradation are output from the corresponding signal lines via the source driver 15, as indicated by curves 60r and 60g in FIG. 4B, respectively.

In the blue pixels, as indicated by a curve 60b in FIG. 4B, the gradation voltage (output voltage) in accordance with the input gradation is increased by the correction value compared to the output voltages for the red and green pixels as indicated by the curves 60r and 60g, respectively, and then is output from the corresponding signal lines via the source driver 15. Thus, the transmittance of the illumination light becomes higher in the blue pixels than in the red and green pixels, so that yellow caused by the yellowing can be cancelled, preventing degradation of the display quality.

In the above explanation, the gradation voltage for the blue pixels is increased to improve the transmittance of the illumination light in the blue pixels. However, when the degree of whiteness of the illumination light is reduced due to the yellowing, as described above, the gradation voltages for the red and green pixels may be decreased to reduce the transmittance of the illumination light in the red and green pixels. This also can suppress a reduction in the degree of whiteness.

As described above, this embodiment uses the color sensor (chromaticity change acquiring portion) 13 to acquire a change in chromaticity of the illumination light from the light-emitting diodes (light source) 4. Moreover, this embodiment uses the correction determining portion 14c that determines the correction values of the gradation voltages for each color of the red, green, and blue pixels based on the detection results of the color sensor 13. Further, this embodiment uses the gradation voltage output portion 14d that corrects the gradation voltages for each of the red, green, and blue pixels, which have been determined in accordance with the external video signal by the image processing portion 14a, based on the correction values of the respective colors transmitted from the correction determining portion 14c, and outputs the indication signals that indicate the new gradation voltages for each of the red, green, and blue pixels to the source driver 15. Therefore, in this embodiment, even if the chromaticity of the illumination light is changed due to aged deterioration of the light-emitting diodes 4 or the like, the correction determining portion 14c can determine appropriate correction values of the gradation voltages for each color of the red, green, and blue pixels so as to cancel the chromaticity change of the illumination light, and the correction values of the gradation voltages thus determined can be output to the source driver (i.e., the liquid crystal display device 1) 15 via the gradation voltage output portion 14d. Consequently, unlike the conventional examples in which the supply current values of the individual light-emitting diodes are varied, this embodiment can prevent degradation of the display quality even if the chromaticity of the illumination light from the light-emitting diodes 4 is changed, regardless of the luminous color or type of the light-emitting diodes 4.

Moreover, this embodiment can prevent degradation of the display quality, and thus can easily achieve the liquid crystal display device 1 with excellent display performance that is capable of preventing degradation of the display quality even if the chromaticity of the illumination light from the light-emitting diodes 4 is changed.

In this embodiment, since the color sensor 13 for detecting the chromaticity of each of red light, green light, and blue light contained in the illumination light is used, the correction determining portion 14c can determine the correction values of the gradation voltages with high precision and output them to the gradation voltage output portion 14d, thereby reliably preventing degradation of the display quality of the liquid crystal display device 1.

### Embodiment 2

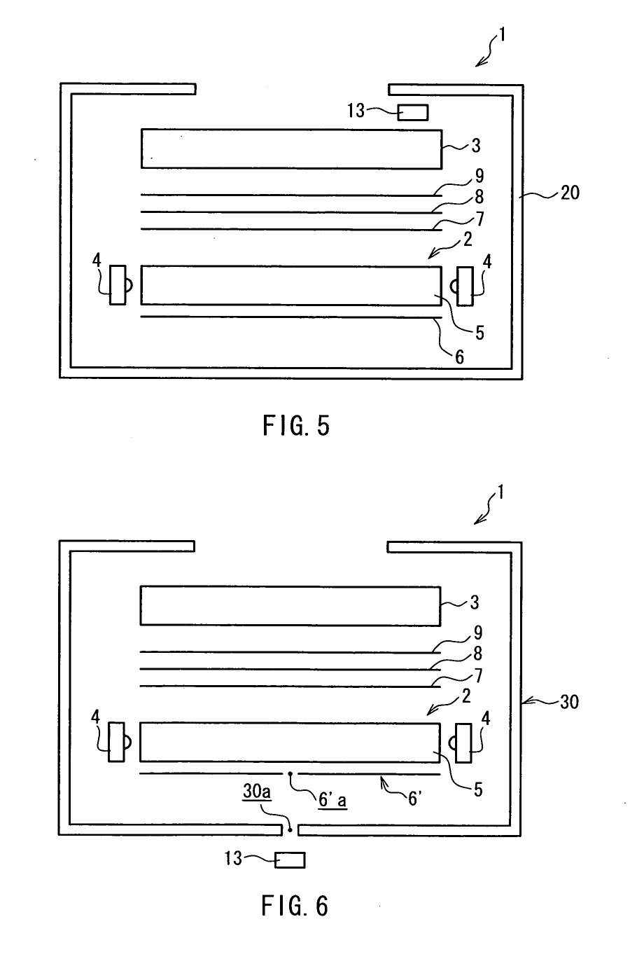

FIG. 5 is a schematic view showing a gradation voltage correction system and a liquid crystal display device according to Embodiment 2 of the present invention. In the drawing, this embodiment differs from Embodiment 1 mainly in that the color sensor is located on the display surface side of the liquid crystal panel. The same components as those in Embodiment 1 are denoted by the same reference numerals, and the explanation will not be repeated.

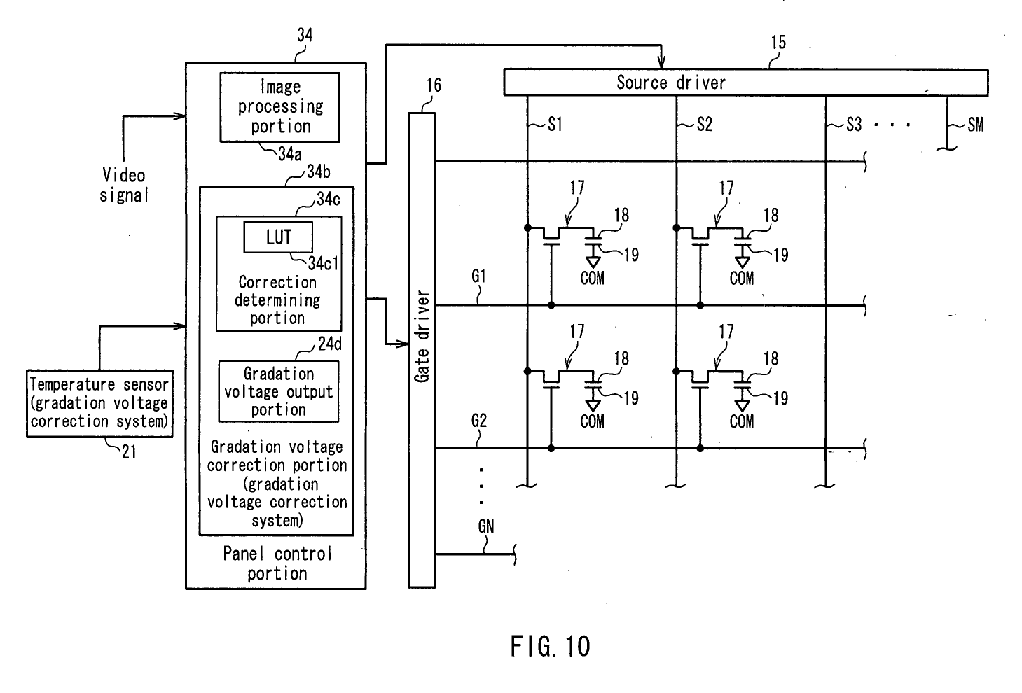

As shown in FIG. 5, in the liquid crystal display device 1 of this embodiment, the backlight device 2, the liquid crystal panel 3, etc. are housed in a bezel 20 serving as a case. For the sake of simplification, the FIG. 10, the drive control circuit 11, and the lighting drive circuit 12 are omitted from FIG. 5 (the same is true for the following FIGS. 6, 7, and 9).

In this embodiment, the color sensor 13 is located on the display surface side of the liquid crystal panel 3. As in the case of Embodiment 1, the color sensor 13 is located in a region other than the effective display area of the liquid crystal panel (display portion) 3, and can reliably prevent reductions in brightness and display quality of the liquid crystal panel 3.

With the above configuration, this embodiment can have similar effects to those of Embodiment 1. Unlike the conventional examples, this embodiment can prevent degradation of the display quality even if the chromaticity of the illumination light from the light-emitting diodes 4 is changed, regardless of the luminous color or type of the light-emitting diodes 4, and thus can easily achieve the liquid crystal display device 1 with excellent display performance.

### Embodiment 3

FIG. 6 is a schematic view showing a gradation voltage correction system and a liquid crystal display device according to Embodiment 3 of the present invention. In the drawing, this embodiment differs from Embodiment 2 mainly in that the color sensor is located outside the bezel. The same components as those in Embodiment 2 are denoted by the same reference numerals, and the explanation will not be repeated.

As shown in FIG. 6, in the liquid crystal display device 1 of this embodiment, the backlight device 2, the liquid crystal panel 3, etc. are housed in a bezel 30 serving as a case. Unlike Embodiment 2, the liquid crystal display device 1 of this embodiment uses a reflection sheet 6′ having an opening 6′a in the center, and the color sensor 13 located outside the bezel 30 is configured to be capable of detecting the illumination light (the details of which will be described later).

The bezel 30 has an opening 30a that is provided, e.g., opposite to the center of the light guide plate 5. Moreover, the opening 6′a of the reflection sheet 6′ is present on the upper side of the opening 30a so that they face each other. On the other hand, the color sensor 13 is placed on the lower side of the opening 30a so that they face each other. Thus, the color sensor 13 detects the illumination light emitted through the openings 6′a and 30a. As in the case of Embodiment 1, the color sensor 13 is located in a region other than the effective display area of the liquid crystal panel (display portion) 3, and can reliably prevent reductions in brightness and display quality of the liquid crystal panel 3.

With the above configuration, this embodiment can have similar effects to those of Embodiment 2. Unlike the conventional examples, this embodiment can prevent degradation of the display quality even if the chromaticity of the illumination light from the light-emitting diodes 4 is changed, regardless of the luminous color or type of the light-emitting diodes 4, and thus can easily achieve the liquid crystal display device 1 with excellent display performance.

### Embodiment 4

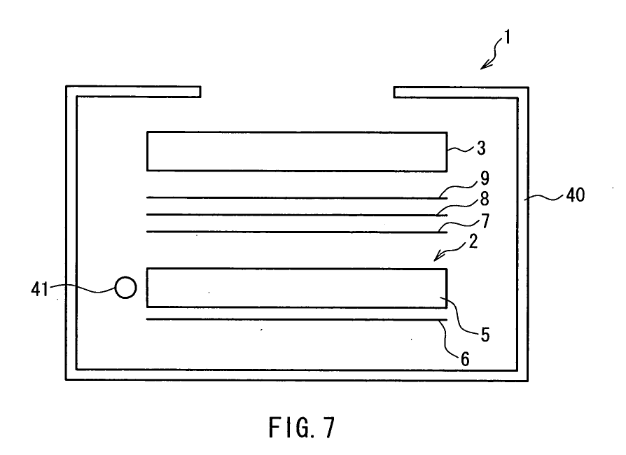

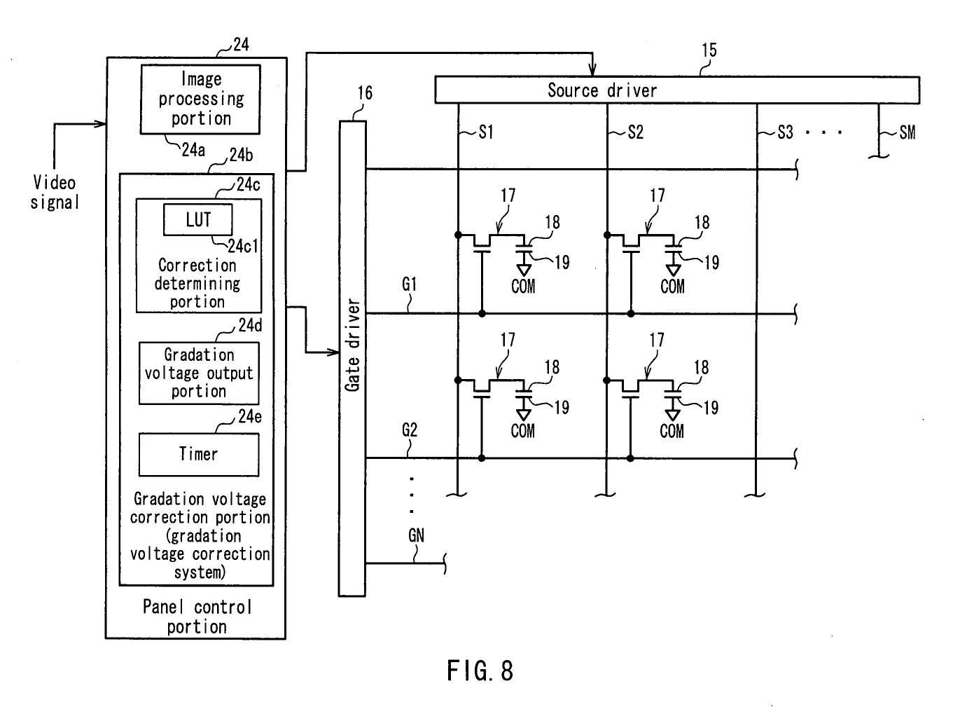

FIG. 7 is a schematic view showing a gradation voltage correction system and a liquid crystal display device according to Embodiment 4 of the present invention. FIG. 8 is a diagram for explaining the configuration of the main portion of the gradation voltage correction system and the liquid crystal panel shown in FIG. 7. In the drawing, this embodiment differs from Embodiment 1 mainly in that a cold-cathode tube is used as a light source, and a timer for measuring a lighting time of the cold-cathode tube is provided instead of the color sensor. The same components as those in Embodiment 1 are denoted by the same reference numerals, and the explanation will not be repeated.

As shown in FIG. 7, in the liquid crystal display device 1 of this embodiment, the backlight device 2, the liquid crystal panel 3, etc. are housed in a bezel 40 serving as a case. Unlike Embodiment 1, in the liquid crystal display device 1 of this embodiment, a cold-cathode tube 41 is located opposite to the left surface of the light guide plate 5 in FIG. 7 and used as a light source instead of the light-emitting diodes.

As shown in FIG. 8, the liquid crystal display device 1 of this embodiment includes a panel control portion 24 in which an image processing portion 24a is integrated with a gradation voltage correction portion 24b. The image processing portion 24a generates indication signals for the source driver 15 and the gate driver 16 based on the external video signal. The gradation voltage correction portion 24b constitutes the gradation voltage correction system of this embodiment. In this embodiment, a timer 24e for measuring a lighting time of the cold-cathode tube 41 is provided inside the gradation voltage correction portion 24b instead of the color sensor 13, and the gradation voltage correction portion 24b including all the components of the gradation voltage correction system of this embodiment is integrally incorporated into the panel control portion 24.

Specifically, the gradation voltage correction portion 24b includes the timer 24e, a correction determining portion 24c, and a gradation voltage output portion 24d. The correction determining portion 24c determines correction values of the gradation voltages for each color of the red, green, and blue pixels based on the measurement results of the timer 24e. The gradation voltage output portion 24d receives the indication signals for the source driver 15 from the image processing portion 24a and the correction values of the gradation voltages determined by the correction determining portion 24c, corrects the indication signals for the source driver 15 using the input correction values, and outputs the corrected indication signals to the source driver 15.

The timer 24e is used as a chromaticity change acquiring portion for acquiring a change in chromaticity of the illumination light and configured to be capable of measuring both a cumulative time including all the lighting times of the cold-cathode tube 41 that have been added together and an elapsed time from a lighting start point at which the cold-cathode tube 41 is turned on.

The correction determining portion 24c uses a LUT 24c1 that is connected to the timer 24e and the gradation voltage output portion 24d. Therefore, even if the chromaticity of the illumination light is changed, the correction determining portion 24c determines the correction values of the gradation voltages for each color of the red, green, and blue pixels so as to cancel the chromaticity change of the illumination light. In the LUT 24c1, both the cumulative time and the elapsed time included in the measurement results of the timer 24e and the optimum correction values of the gradation voltages have been previously obtained by performing a test or simulation and correlated for each color of red light, green light, and blue light.

More specifically, in the LUT 24c1, the elapsed time and the correction values are correlated so that the correction values for the elapsed time are changed every predetermined cumulative time (e.g., 100 hours). In the correction determining portion 24c, when the measurement results of the timer 24e are input to the LUT 24c1, the correction values of the gradation voltages for each color of the red, green, and blue pixels in accordance with the measurement results are immediately transmitted to the gradation voltage output portion 24d.

Besides the above explanation, e.g., four LUTs may be used for cumulative times of less than 5000 hours, not less than 5000 hours and less than 10000 hours, not less than 10000 hours and less than 15000 hours, and not less than 15000 hours and less than 20000 hours, respectively.

Upon receiving the correction values of the gradation voltages for each color of the red, green, and blue pixels from the LUT 24c1, the gradation voltage output portion 24d corrects the indication signals for the source driver 15 that have been input from the image processing portion 24a using the correction values and then outputs the corrected indication signals as new indication signals to the source driver 15. In other words, the gradation voltage output portion 24d corrects the gradation voltages for each of the red, green, and blue pixels, which have been determined in accordance with the video signal by the image processing portion 24a, based on the correction values of the respective colors transmitted from the LUT 24c1, and provides new gradation voltages. Then, the gradation voltage output portion 24d generates indication signals that indicate the new gradation voltages for each of the red, green, and blue pixels and outputs them to the source driver 15. Thus, in the liquid crystal panel 3, the transmittance of the illumination light from the backlight device 2 is changed for each of the red, green, and blue pixels in accordance with the new gradation voltages from the gradation voltage output portion 24d. Consequently, even if the chromaticity of white light from the cold-cathode tube 41 is changed due to, e.g., aged deterioration of the cold-cathode tube 41 and/or lighting initial characteristics, it is possible to prevent degradation of the display quality of the liquid crystal display device 1.

Besides the above explanation, the gradation voltage output portion 24d may output the correction values of the gradation voltages determined by the correction determining portion 24c to the image processing portion 24a, and then the image processing portion 24a may determine new gradation voltages for each of the red, green, and blue pixels based on the correction values and output the new gradation voltages as indication signals to the source driver 15.

With the above configuration, this embodiment can have similar effects to those of Embodiment 1. Unlike the conventional examples, this embodiment can prevent degradation of the display quality even if the chromaticity of the illumination light from the cold-cathode tube 41 is changed, regardless of the luminous color or type of the cold-cathode tube 41, and thus can easily achieve the liquid crystal display device 1 with excellent display performance.

Moreover, this embodiment uses the timer (chromaticity change acquiring portion) 24e to acquire a change in chromaticity of each of red light, green light, and blue light contained in the illumination light. Therefore, this embodiment can prevent degradation of the display quality of the liquid crystal display device 1 while simplifying the structure of the gradation voltage correction system. According to this embodiment, the gradation voltage correction system can be easily incorporated into the existing liquid crystal display device, so that high performance of this liquid crystal display device can be readily achieved.

In the above explanation, the timer 24e is provided inside the gradation voltage correction portion 24b that is integrally incorporated into the panel control portion 24. However, the placement of the timer 24e is not limited thereto. Moreover, the timer 24e is not particularly limited as long as it can measure the lighting time of the cold-cathode tube (light source) 41. For example, when a microcomputer is used in the lighting drive circuit 12 that drives the cold-cathode tube 41 with an inverter, the timer 24e may be composed of a dock generator of the microcomputer and a counter for counting the clock signals of the dock generator in accordance with the lighting time of the cold-cathode tube 41.

### Embodiment 5

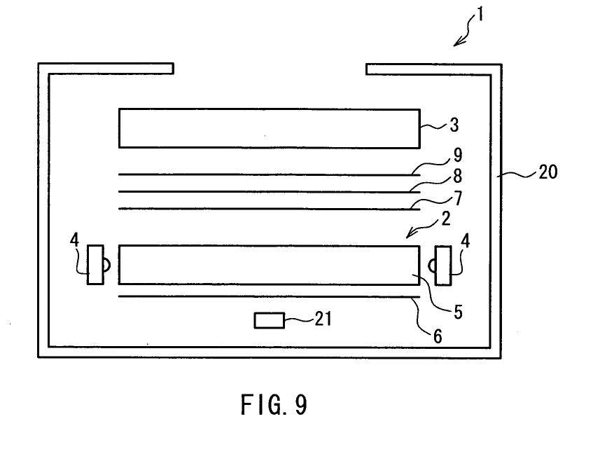

FIG. 9 is a schematic view showing a gradation voltage correction system and a liquid crystal display device according to Embodiment 5 of the present invention. FIG. 10 is a diagram for explaining the configuration of the main portion of the gradation voltage correction system and the liquid crystal panel shown in FIG. 9. In the drawing, this embodiment differs from Embodiment 1 mainly in that a temperature sensor for detecting an ambient temperature of the light-emitting diodes is used instead of the color sensor. The same components as those in Embodiment 1 are denoted by the same reference numerals, and the explanation will not be repeated.

As shown in FIG. 9, in the liquid crystal display device 1 of this embodiment, the backlight device 2, the liquid crystal panel 3, etc. are housed in a bezel 20 serving as a case. Unlike Embodiment 1, in the liquid crystal display device 1 of this embodiment, a temperature sensor 21 is located on the lower side of the reflection sheet 6 to detect the ambient temperature of the light-emitting diodes 4 instead of the color sensor. The temperature sensor 21 is included in the gradation voltage correction system of this embodiment and used as a chromaticity change acquiring portion for acquiring a change in chromaticity of the illumination light.

As shown in FIG. 10, the liquid crystal display device 1 of this embodiment includes a panel control portion 34 in which an image processing portion 34a is integrated with a gradation voltage correction portion 34b. The image processing portion 34a generates indication signals for the source driver 15 and the gate driver 16 based on the external video signal. The gradation voltage correction portion 34b is included in the gradation voltage correction system of this embodiment.

Specifically, the gradation voltage correction portion 34b includes a correction determining portion 34c and a gradation voltage output portion 34d. The correction determining portion 34c determines correction values of the gradation voltages for each color of the red, green, and blue pixels based on the detection results of the temperature sensor 21. The gradation voltage output portion 34d receives the indication signals for the source driver 15 from the image processing portion 34a and the correction values of the gradation voltages determined by the correction determining portion 34c, corrects the indication signals for the source driver 15 using the input correction values, and outputs the corrected indication signals to the source driver 15.

The correction determining portion 34c uses a LUT 34c1 that is connected to the temperature sensor 21 and the gradation voltage output portion 34d. Therefore, even if the chromaticity of the illumination light is changed, the correction determining portion 34c determines the correction values of the gradation voltages for each color of the red, green, and blue pixels so as to cancel the chromaticity change of the illumination light. In the LUT 34c1, the chromaticity included in the detection results of the temperature sensor 21 and the optimum correction values of the gradation voltages have been previously obtained by performing a test or simulation and correlated for each color of red light, green light, and blue light. In the correction determining portion 34c, when the detection results of the temperature sensor 21 are input to the LUT 34c1, the correction values of the gradation voltages for each color of the red, green, and blue pixels in accordance with the detection results are immediately transmitted to the gradation voltage output portion 34d.

Upon receiving the correction values of the gradation voltages for each color of the red, green, and blue pixels from the LUT 34c1, the gradation voltage output portion 34d corrects the indication signals for the source driver 15 that have been input from the image processing portion 34a using the correction values and then outputs the corrected indication signals as new indication signals to the source driver 15. In other words, the gradation voltage output portion 34d corrects the gradation voltages for each of the red, green, and blue pixels, which have been determined in accordance with the video signal by the image processing portion 34a, based on the correction values of the respective colors transmitted from the LUT 34c1, and provides new gradation voltages. Then, the gradation voltage output portion 34d generates indication signals that indicate the new gradation voltages for each of the red, green, and blue pixels and outputs them to the source driver 15. Thus, in the liquid crystal panel 3, the transmittance of the illumination light from the backlight device 2 is changed for each of the red, green, and blue pixels in accordance with the new gradation voltages from the gradation voltage output portion 34d. Consequently, even if the chromaticity of white light from the light-emitting diodes 4 is changed due to, e.g., ambient temperature changes of the light-emitting diodes 4, it is possible to prevent degradation of the display quality of the liquid crystal display device 1.

Besides the above explanation, the gradation voltage output portion 34d may output the correction values of the gradation voltages determined by the correction determining portion 34c to the image processing portion 34a, and then the image processing portion 34a may determine new gradation voltages for each of the red, green, and blue pixels based on the correction values and output the new gradation voltages as indication signals to the source driver 15.

With the above configuration, this embodiment can have similar effects to those of Embodiment 1. Unlike the conventional examples, this embodiment can prevent degradation of the display quality even if the chromaticity of the illumination light from the light-emitting diodes 4 is changed, regardless of the luminous color or type of the light-emitting diodes 4, and thus can easily achieve the liquid crystal display device 1 with excellent display performance.

Moreover, this embodiment uses the temperature sensor (chromaticity change acquiring portion) 21 to acquire a change in chromaticity of each of red light, green light, and blue light contained in the illumination light. Therefore, even if the emission characteristics of the light-emitting diodes 4 vary with ambient temperature, and thus the chromaticity of the illumination light is changed, it is possible to reliably prevent degradation of the display quality of the liquid crystal display device 1.

It should be noted that the above embodiments are all illustrative and not restrictive. The technological scope of the present invention is defined by the appended claims, and all changes that come within the range of equivalency of the claims are intended to be embraced therein.

For example, although the above description has been directed to the case of applying the present invention to a transmission type liquid crystal display device, the gradation voltage correction system of the present invention is not limited thereto. The present invention can be applied to various display devices including a non-luminous display portion that utilizes light from a light source to display information such as an image and a character. Specifically, the gradation voltage correction system of the present invention can be used in a semi-transmission type liquid crystal display device or a projection display device such as a rear projection in a preferred manner.

Moreover, although the above description has been directed to the case of applying the present invention to the liquid crystal display device that includes the edge light type backlight device using the light guide plate, the gradation voltage correction system of the present invention is not limited thereto, and can also be applied to a liquid crystal display device that includes a direct light type backlight device in which the light source is located on the underside of the liquid crystal panel.

In the above description, the gradation voltage correction portion is integrally incorporated into the panel control portion in the liquid crystal display device. However, the gradation voltage correction system of the present invention may be separated, e.g., from the panel control portion as long as it includes the following: a chromaticity change acquiring portion for acquiring a change in chromaticity of the illumination light that is directed to each of the red, green, and blue pixels provided in the display device; a correction determining portion for determining correction values of the gradation voltages, which have been determined pixel by pixel in accordance with the information to be displayed on the display device, for each color of the red, green, and blue pixels based on the acquisition results of the chromaticity change acquiring portion; and a gradation voltage output portion for outputting the correction values of the gradation voltages from the correction determining portion to the display device. In this case, however, it is preferable to integrally form the panel control portion with the gradation voltage correction portion because the configuration of the display device can be simplified.

In the above description, the look-up table (LUT) is used in the correction determining portion. However, the correction determining portion of the present invention is not limited thereto, and may include, e.g., a memory and an arithmetic section such as CPU or MPU. In such a case, the memory stores the sensor detection results (of a color sensor etc.) or the timer measurement results and the correction values of the gradation voltages that have been previously correlated. The arithmetic section receives the sensor detection results or the timer measurement results and retrieves the corresponding correction values from the memory using the input detection or measurement results data.

However, as described in each of the above embodiments, it is preferable to use the LUT in the correction determining portion because the correction values of the gradation voltages can be instantly determined, and thus degradation of the display quality can be immediately prevented even if the chromaticity of the illumination light is changed. Moreover, since the correction determining portion can be configured without the arithmetic section, the configuration of the gradation voltage correction system can be easily simplified.

In each of Embodiments 1 to 3, the color sensor for detecting the chromaticity of each of red light, green light, and blue light is used as the chromaticity change acquiring portion. However, the chromaticity change acquiring portion of the present invention is not limited thereto, and may include a color sensor for detecting the brightness of each of red light, green light, and blue light and an arithmetic section for determining the chromaticity of each of the red light, the green light, and the blue light based on the brightness detection results of this color sensor, thereby acquiring a change in chromaticity of the illumination light. Alternatively, the chromaticity change acquiring portion may include a light amount sensor for detecting the light amount of each of red light, green light, and blue light and an arithmetic section for determining the chromaticity of each of the red light, the green light, and the blue light based on the light amount detection results of this light amount sensor, thereby acquiring a change in chromaticity of the illumination light.

In each of Embodiments 1 to 3 and 5, the white light-emitting diodes are used as the light source. In Embodiment 4, the cold-cathode tube is used as the light source. However, the light source of the present invention is not limited thereto, and may be, e.g., three types of light-emitting diodes for emitting R, G, and B colors of light, respectively, a discharge tube such as a hot-cathode tube or a xenon tube, or a combination of the light-emitting diodes and the discharge tube, namely a so-called hybrid type light source.

Besides the above description, any of Embodiments 1 to 5 may be appropriately combined.

### INDUSTRIAL APPLICABILITY

The present invention is useful for a gradation voltage correction system that can prevent degradation of the display quality even if the chromaticity of illumination light from a light source is changed, and a high-performance display device using the same.

1. A gradation voltage correction system for correcting gradation voltages to be supplied to a plurality of red, green, and blue pixels provided in a display device that is configured to be capable of displaying information pixel by pixel using illumination light from a light source,
the gradation voltage correction system comprising:
a chromaticity change acquiring portion for acquiring a change in chromaticity of the illumination light;
a correction determining portion for determining correction values of the gradation voltages for each color of the red, green, and blue pixels based on the acquisition results of the chromaticity change acquiring portion; and
a gradation voltage output portion for outputting the correction values of the gradation voltages from the correction determining portion to the display device.

2. The gradation voltage correction system according to claim 1, wherein the chromaticity change acquiring portion comprises a color sensor for detecting chromaticity of the illumination light.

3. The gradation voltage correction system according to claim 2, wherein the color sensor is located in a region other than an effective display area of a display portion provided in the display device.

4. The gradation voltage correction system according to claim 1, wherein the chromaticity change acquiring portion comprises a timer for measuring a lighting time of the light source.

5. The gradation voltage correction system according to claim 4, wherein the timer measures both a cumulative time including all the lighting times of the light source that have been added together and an elapsed time from a lighting start point at which the light source is turned on.

6. The gradation voltage correction system according to claim 1, wherein the chromaticity change acquiring portion comprises a temperature sensor for detecting an ambient temperature of the light source.

7. The gradation voltage correction system according to claim 1, wherein the correction determining portion comprises a look-up table that correlates the acquisition results of the chromaticity change acquiring portion with the correction values of the gradation voltages.

8. A display device using the gradation voltage correction system according to claim 1.

9. The display device according to claim 8, comprising a liquid crystal panel used as a display portion for displaying information,
wherein in the liquid crystal panel, a transmittance of the illumination light is changed for each pixel in accordance with the correction values of the gradation voltages from the gradation voltage output portion.
